(19) United States
(12) Patent Application Publication
(10) Pub. No.: US 2002/0138324 A1
(43) Pub. Date: Sep. 26, 2002

(54) System and method for supply chain management, including collaboration

(75) Inventors: Kurt A. Zarefoss, Middletown, MD (US); Tom Drolet, Germantown, MD (US); Lisa Carlin, Frederick, MD (US); John Vrankovich, Reston, VA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics, Inc.

(21) Appl. No.: 09/965,854

(22) Filed: Oct. 1, 2001

Related U.S. Application Data
(60) Provisional application No. 60/236,379, filed on Sep. 29, 2000.

(51) Int. Cl. G06F 17/60

(52) U.S. Cl. 705/8

(57) ABSTRACT

A system and method for sharing and manipulating supply chain data by assigning attributes to the data, creating hierarchies, calendars, filters and freeze profiles. Manipulation of the data may be accomplished by allocation, aggregation and conversion using predefined relationships and rules. Selective sharing of data may be accomplished by predefined partnerships and filters. System users are able to selectively view the data in a customize desirable format.

### CROSS REFERENCE TO RELATED APPLICATION

This application claims priority from U.S. Provisional Patent Application Serial No. 60/236,379, filed Sep. 29, 2000, the disclosure of which is hereby incorporated reference by its entirety.

### FIELD OF THE INVENTION

The invention relates to a system and method for inventory management and control. More specifically, the invention allows supply chain trading partners to selectively share supply chain information with other trading partners in real time.

### BACKGROUND OF THE INVENTION

Conducting business with trading partners can be complex, expensive, inefficient and at times adversarial. Many businesses have difficulty sharing information internally. This difficulty is compounded when businesses try to share information with external trading partners. A trading partner is a supplier, customer, subsidiary, or any other organization or persons that participates in the same supply chain or trading network. Businesses now recognize that improving the effectiveness of the internal supply chain is not enough. Instead, businesses are seeking to improve the efficiency of the entire trading network.

A supply chain is typically a complex network of people and organizations that interact dynamically to produce and sell a product or a service. For a supply chain to operate in an efficient manner, supply chain trading partners should work in sync with each other for obvious reasons. Unfortunately this often does not occur.

One reason for the lack of synchronization among supply chain trading partners is unexpected changes in the environment. For example, certain events such as a sudden decrease in demand, labor problems, supply shortage, and the like, may have a reverberating impact throughout a supply chain even when such events only directly affect a small portion of the supply chain. This is because of the high level of interdependency of all trading partners within a typical supply chain.

In addition to the highly interdependent nature of a typical supply chain, there is also the problem of the general unresponsiveness of supply chain trading partners to changes in the environment. There are many reasons why supply chain participants may be unresponsive to environmental changes.

Supply chain participants are generally business organizations that typically have a number of commitments to employee unions, lease agreements, suppliers, customers, and the like. These legal commitments are often difficult, if not impossible, to change on short notice. In addition, many of these organizations may have logistical and physical reasons for not being responsive. For example, many manufacturers require a certain amount of lag time to switch product lines or to increase or decrease production because the manufacturing facilities must typically be reprogrammed or restructured to make changes to production. In the case of distributors and suppliers, their storage spaces are often finite and not expandable or contractible. It is very difficult for these businesses to accommodate for any sudden increase in goods coming into their warehouses. On the other hand, if there is a sudden decrease of goods coming into their warehouses or there is a surge in demand and they are unable to keep their warehouse fully utilized, they will not likely be able to lease out the excess space in the warehouse. In the case of transportation companies that participate in supply chains, they typically have a finite amount of equipment (e.g., trucks). Even if, for example, a transportation company did have enough equipment to handle a surge in demand, it may not be able to relocate the equipment to the right location because of logistical limitations. On the other hand, if there is a sudden drop in business, these companies may have a difficult time obtaining other businesses in a timely manner to keep their equipment in use. To overcome such problems, supply chain participants may rely on forecasts and business plans to strategize future business operations.

Developing reliable forecasts and business plans require obtaining good information that is highly reliable and the most current. Such information includes, for example, demand forecast, promotions, purchasing orders, inventory, and the like, of other trading partners.

Unfortunately it is often difficult for supply chain trading partners to obtain these highly relevant supply chain information on a timely basis. Sometimes, the relevant information is not immediately available to a trading partner because the information is held by other organizations that do not have direct business relationships with the trading partner. At other times, the information is simply unavailable because there is no system for sharing such information amongst the trading partners.

The inability of trading partners to share information is compounded by the fact that businesses often use different management/collaboration systems. Each of these businesses as a result, may format or view the information that they maintain in contrasting ways. Therefore, even if a trading partner is able to obtain the desired information from others, it may have difficulty interpreting the information so that it conforms to the trading partner's own business practices. For example, many businesses operate according to their own calendars. It would be preferable for these businesses to be able to view relevant information formatted in a manner that conforms to their own business or operational calendar.

Of course, the amount of information that is associated to a supply chain is typically enormous. Trading partners are generally interested only in a portion of the total information associated with a supply chain. Most trading partners do not have the resources to review the huge volume of supply chain information to obtain the desired data. At the same time, trading partners may want to limit the access to some of their own data. That is, a trading partner may want only certain trading partners to be able to access their own data, especially those types of data that tends to be highly confidential.

Finally, the general dynamic nature of a typical supply chain often makes it quite difficult for supply chain participants to share information. Supply chains are, as mentioned earlier, a complex network of organizations and individuals. It is not a stationary network but rather a constantly evolving network. Organizations and individuals are constantly moving in and out of a typical supply chain. There may also be several realignment of business relationship between trading partners within the lifetime of a supply chain.

All of these factors make it difficult for those participating in supply chains to efficiently share supply chain information.

Thus, a highly flexible system for sharing supply chain information that allows a supply chain trading partner to share selective information with other trading partners and to automatically obtain only relevant information in real time and in a format that would be compatible with the trading partner's needs would be highly desirable. Such a system should have great flexibility so that it can handle the dynamic nature of a typical supply chain.

### SUMMARY OF THE INVENTION

To solve the problems cited above, the present invention provider, among other things, a system and methods for sharing and manipulating supply chain information. In general, the present invention provides for a system and method that stores supply chain information and allows supply chain participants to access and manipulate selective supply chain information so that the participants may retain the information in a desirable format.

In a preferred embodiment, trading partners of a supply chain may store supply chain planning data, such as demand forecast, supply forecast, promotional forecast, purchasing order information, and the like, in a database. The data may be organized into entities called supply chain planning items and planning components by assigning attributes to the data. At least two attributes are assigned to the data. In addition, user defined attributes may also be assigned to the data.

Based on at least one of the attributes assigned, a hierarchy may be created. The hierarchy may be created by ranking and placing the attributes into a hierarchical order. The data may be manipulated by aggregating the data in accordance with the hierarchy. By aggregating the data of lower level hierarchical planning data, higher level hierarchical planning items may be obtained.

According to another embodiment, low level hierarchical planning data may be automatically updated by allocation techniques. A user and/or a trading partner may automatically update low level hierarchical planning data simply by updating higher level hierarchical planning data using predefined rules on how the updating high level data is allocated amongst the lower level planning data items.

According to another embodiment, the data may be manipulated by converting the data from data based on a particular unit of measure to another form of data based on another unit of measure. Such conversions may be accomplished using conversion chains having conversion factors. These conversion factors are typically used to multiply or divide the original data to produce the resulting data format.

According to another embodiment, trading partners or users may selectively access only certain stored data. This may be accomplished by creating filters that query for selective data by seeking only data having certain defined attributes. The filters are typically associated with roles. A user or a trading partner will generally be assigned to a role, which allows the user or trading partner to access selective planning data. Each role may be associated with several filters.

According to another embodiment, a customized calendar may be created. The customized calendar may be specifically tailored to support the business needs of a user or a trading partner. The customized calendar may then be employed to organize and manipulate the stored data and allowing users and trading partners to view the data in a more desirable format.

According to another embodiment, a freeze profile may be created. A freeze profile is typically defined by a freeze period. The freeze profile may then be applied to any planning data preventing editing of the data during the freeze period.

In yet another embodiment, the originally stored planning data and any other data produced by manipulation techniques may be viewed on a remote computer device via an electronic network such as the Internet.

As will be readily appreciated by one of ordinary skill in the art, the present invention provides for a robust system and method for sharing and manipulating supply chain data. Additional features and advantages are set forth in the description that follows, and in part are apparent from the description, or may be learned by practice of the invention. The objectives and other advantages of the invention are realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 is an exemplary supply chain;

FIG. 2 is a block diagram depicting one embodiment of the system for supply chain management of the present invention;

FIG. 3A is a block diagram depicting the relationship between attributes and a planning item, in accordance with an embodiment of the present invention;

FIG. 3B is a block diagram depicting the relationship between planning items and planning components, in accordance with an embodiment of the present invention;

FIG. 3C is a block diagram depicting the content of a planning component, in accordance with an embodiment of the present invention;

FIG. 4A is a flow diagram depicting the steps for creating a planning component;

FIG. 4B is a flow diagram depicting the steps for creating a derived planning component;

FIG. 5A is a flow diagram depicting the steps for creating a filter;

FIG. 5B is a flow diagram depicting the steps for creating a calendar;

FIG. 6 is a flow diagram depicting the steps for creating a hierarchy;

FIG. 7 is a block diagram depicting an exemplary hierarchy having three node levels and branches created using the process of FIG. 6;

FIGS. 8-10 are exemplary displays of a user interface for viewing planning data respectively from the top, middle and bottom node levels of the hierarchy of FIG. 7;

FIG. 11 is a flow diagram depicting the steps for creating a freeze profile;

FIG. 12 is a flow diagram depicting the general process steps for acquiring planning data according to the present invention; and

FIG. 13 is a flow diagram depicting the general process steps for editing planning data according to the present invention.

### DETAILED DESCRIPTION OF THE PREFERRED EMBODIMENTS

According to the present invention, there is provided a robust collaboration system (herein “the system”) that allows trading partners to share supply chain information. By sharing such information, the coordination of business activities between trading partners may be better facilitated. Preferably the system has an open architectural framework which allows the system to interface with trading partners who may have assorted collaboration/management systems. In one embodiment, the system will be compatible with Collaborative Planning, Forecasting and Replenishment (“CPFR”) Voluntary Guidelines and RosettaNet, the industry-wide e-business communication standards.

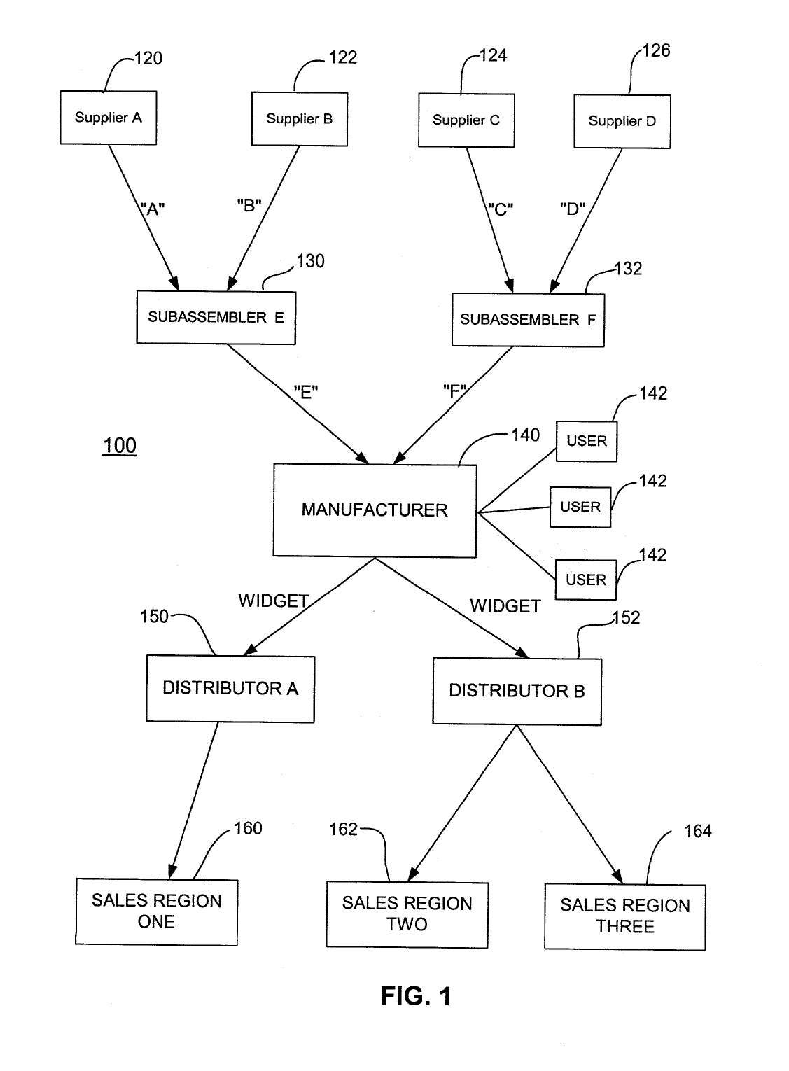

Although supply chains may be configured in an infinite number of ways, to facilitate the understanding of the features of the present invention, an exemplary supply chain will now be provided. FIG. 1 depicts an exemplary supply chain 100 made up of multiple layers of supply chain trading partners. The supply chain 100 comprises suppliers 120, 122, 124 and 126 at a top tier of the supply chain 100 producing components A, B, C, and D, respectively, which are sent to sub-assemblers 130 and 132 in a second tier. Sub-assemblers 130 and 132 then assembles components A, B, C, and D to produce components E and F, respectively, which are sent to a manufacturer 140. A trading partner may be an organization, a business enterprise, or an individual, etc. Each supply chain trading partner may comprise of or may be in communication with users who are employees, associates, subsidiaries or any other business sub-units of the trading partner. For example, in FIG. 1, the manufacturer 140 is in communication with users 142 associated with the manufacturer. Using components E and F, the manufacturer 140 produce widgets that are sent to distributor A 150 and distributor B 152, who then distribute the widgets to the various sales regions 160, 162 and 164.

Despite the simplistic example of FIG. 1, the relationship between various members of a supply chain community is generally complex and dynamic. Trading partners in a supply chain typically have direct business relationships with other trading partners in the same supply chain. Trading partners may also have indirect relationships with other trading partners within the same supply chain. That is, it is possible for one trading partner to have a significant influence over another's business operation without having a direct business relationship with the other trading partner. For example, if the distributor A 150 reduces its purchase order from the manufacturer 140 for widgets based on its demand forecast for widgets in sales region one 160, then the manufacturer 140 likely reduces its output of widgets. In turn, the manufacturer 140 reduces its purchase of component E from the subassembler E 130. The subassembler E 130 in turn reduces its order for component A, requiring the supplier A 120 to cut its production. Thus, although the distributor A 150 did not have a direct business relationship with the supplier A 120, its activities ultimately impact the supplier A 120.

For the supply chain to operate in a most efficient manner, it would be preferable for each of the trading partners to have updated information from its partners. If the business plans and forecasts of a trading partner do not match actual demand and supply chain conditions, then the production and/or the supply of products may not be in sync with actual demand. As a result, the various business flows of the supply chain may become disjointed. For example, referring back to FIG. 1, if instead of reduction in demand, the distributor A 150 forecasts an increase in demand for widgets. As a result, the distributor 150 increases orders for widgets that eventually results in increased orders of component A from the supplier A 120. However, the supplier A 150 may not be able to fulfill the increased order because there may be a lag time for increasing production. Thus, parts of the supply chain 100 become disjointed and demand for a good and/or service is unmet. Other parts of the supply chain 100 may also be affected as a result. For example, to accommodate the increased orders from the distributor A 150, the manufacturer 140 may shift some of the shipment of widgets originally destined for the distributor B 152 to the distributor A 150. In any event, the example here illustrates how events in one part of the supply chain may have a significant effect on other parts of the supply chain that may not even be directly linked to the part where the event occurred.

As described above, the complexities of a typical supply chain makes it highly preferable for each participant of the supply chain to get the best available data in the shortest period of time. Such timely information helps each participant in a supply chain to develop accurate forecasts and proper business plans, facilitating the ordering and purchasing actions amongst the various parties.

Improving supply chain efficiency can bring about many benefits, including better on-time delivery, shorter fulfillment time, less inventory investment, higher productivity per employee, improvement in cash-to-cash cycle time and less money spent on material acquisition.

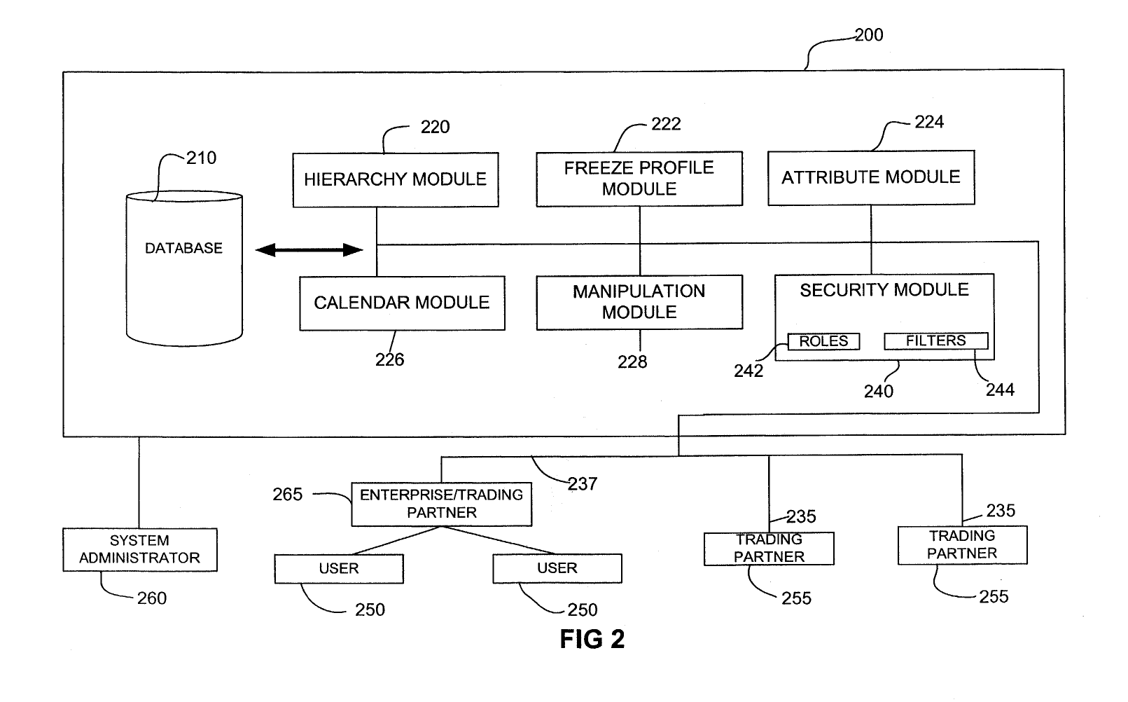

FIG. 2 depicts a collaboration system 200 according to one embodiment of the present invention that facilitates the sharing of information between trading partners of a supply chain. In one embodiment, the system 200 includes a database 210 in which, inter alia, supply chain information may be stored. Supply chain information may include, for example, demand forecast, supply forecast, promotional forecast, purchasing order information, and the like, for any point in the supply chain and for any supply chain participant. Further, the database 210 may store other types of data including information related to hierarchies, user roles, freeze profiles, products, locations, planning items, and the like, all of which are described below.

In addition to the database 210, the system 200 further includes a hierarchy module 220, a freeze profile module 222, an attribute module 224, a calendar module 226, a manipulation module 228 and a security module 240. The system 200 communicates with trading partners 255 via communication lines 235. Similarly, enterprise 265 communicates with the system 200 via communication lines 237. The communication lines 235 and 237 may be a wire or a wireless communication line. The enterprise 265 is in communication with users 250 who are associated with the enterprise 265. The enterprise 265 is in fact, a trading partner but has been depicted differently from the other trading partners 250 to illustrate the relationship between an enterprise (trading partner) and its users 250. The trading partners 255 may be any persons and/or organizations that participate in the supply chain and interfaces with the system 200. Further, a trading partner 255 may be an electronic network of a business entity made up of many interconnected computer devices such as Personal Computers (PCs). Essentially a trading partner 250 may be anybody or anything that has an interest in and/or participates in the supply chain that is associated with the system 200. The security module 240 is the general method of channeling information to users 250 by using two primary means of channeling, roles 242 and filters 244 (which is described in greater detail below). The modules 220-228 and 240, employed together, help users 250 obtain, organize and view relevant planning data. Planning data is any supply chain information used by the users 250, the enterprise 265 and/or the trading partners 255 in the course of their business operations. For example, forecasting data, promotional data, order information, and the like.

The system 200 may be located on a server managed by a system administrator 260. The system administrator 260 may be a user 250, the user's enterprise 265 or a third party. The system may run on a variety of Windows® and UNIX® based systems. For example, the system server may run on Windows® NT 4.0 SP6a server with Oracle® 8i and WebLogic Application Web server 6.0. Although only one database 210 is shown in FIG. 2, the system 200 may comprise of a plurality of databases. Alternatively, the database or databases may be located separately from the modules on a separate server. The actual physical implementation of the system is not essential to the implementation of the present invention. Rather, those skilled in the art will recognize that many variations of the physical implementation are possible.

Users 250 may be in communication with the system 200 via electronic networks such as the Internet, an intranet, an extranet, a Value Added Network (“VAN”), VPN and the like. The Internet browser may be, for example, Netscape Navigator or Microsoft Internet Explorer. Those skilled in the art will recognize that this invention may be physically implemented in a number of ways. The various components illustrated in FIG. 2 will now be described in greater detail.

Returning to FIG. 2, the data stored in the database 210 may be provided by users 250 and/or other external sources and may be organized into two types of entities within the database 210. The two entities are planning items 310 and planning components 350.

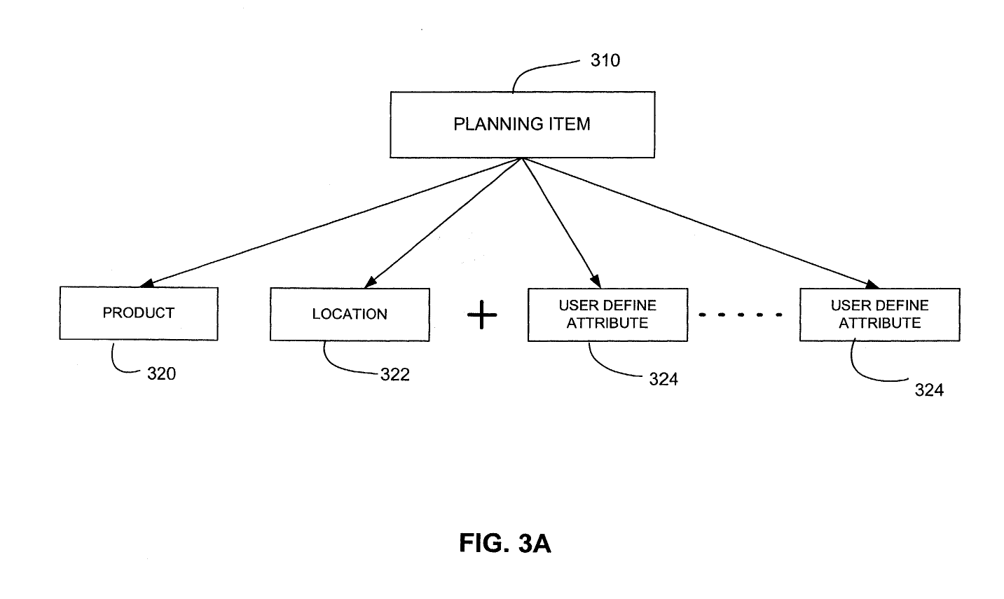

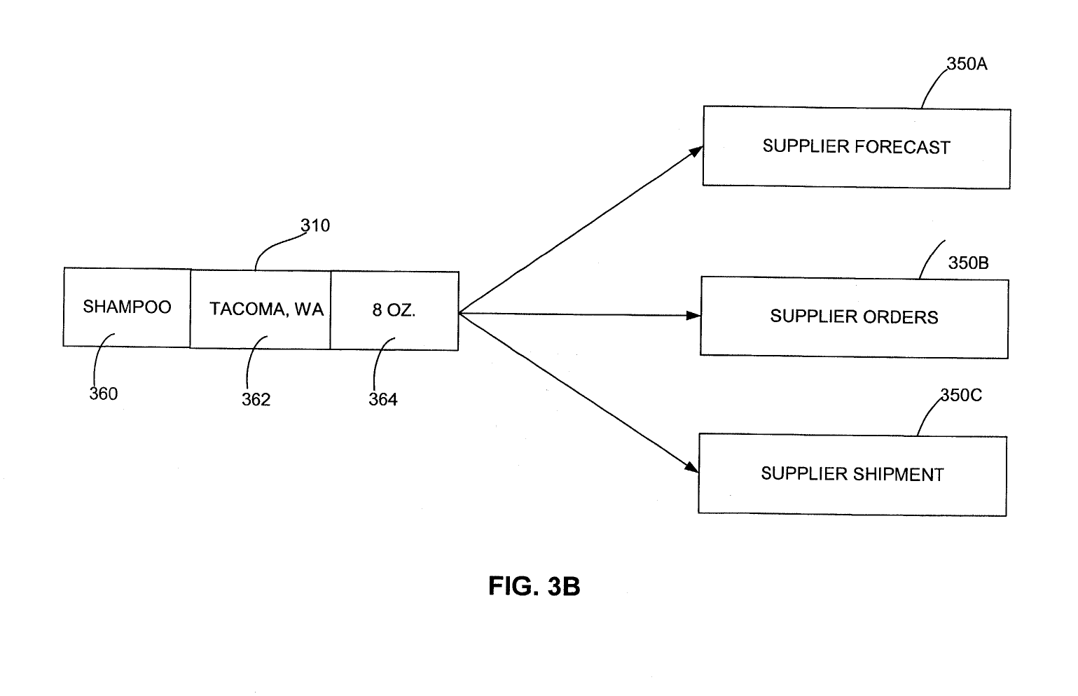

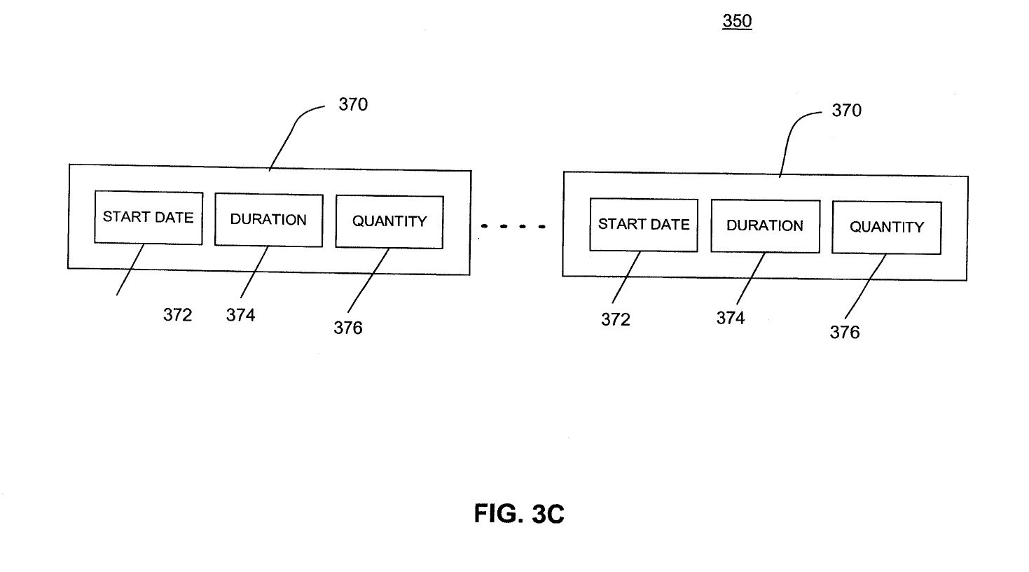

FIG. 3A illustrates a planning item 310 and the attributes 320 to 324 used to identify the planning item 310. A planning item 310 is any item that a user 250 would want to collaborate on with other participants of the system 200. At a minimum, a planning item 310 is preferably identified by at least a product type 320 and location 322. In addition, a planning item 310 may have other identifiers associated with it in the form of user-defined attributes 324 that may be related to, inter alia, a product, a location and/or the planning item itself. The combination of product name attribute 320, location attribute 322 and user defined attributes 324 provides a way to uniquely identify a planning item 310. Each planning item 310 may be related to one or more planning components 350.

The following example provides an illustration of a planning item 310 as it relates to the system 200 of FIG. 2. Suppose the distributor A 150 of FIG. 1 maintains a forecast of projected demand for widgets in sales region one 160. Further, the distributor A 150 may also maintain order and shipment data for widgets in sales region one 160. The distributor A 150 may create a planning item 310, which could be identified by “widget,” as the product attribute 320, and “Sales Region One,” as the location attribute of the distributor A 150. The distributor A 150 may also add additional user defined attributes 324 to the planning item identifier. For example, if the widgets came in three sizes; small, medium and large, another attribute based on product size could be added to the identifier.

FIG. 3B depicts an exemplary planning item 310 and planning components 350A, 350B and 350C that are associated with the planning item 310. A planning component 350A, 350B and 350C may be any type of supply chain planning data, for example, sales forecast, demand forecast, promotional forecast, purchasing order, and the like, for a product or groups of products at any point along the supply chain. Typically, the planning item 310 is a DFU (demand forecast entity) or SKU (stock keeping unit) at the item level (e.g., Peanuts in 12 oz. cans). Each planning item 310 may be associated with one or more planning components 350A, 350B and 350C comprising of time series planning data. In this case, the planning item 310 is identified by three attributes. The two required attributes, product and location attributes, in this case, shampoo 360 and Tacoma, WA 362, and a user defined attribute, 8 oz. 364. In this example, the three planning components 350A, 350B and 350C associated with planning item 310 are supplier forecast 350A, supplier order 350B and supplier shipment 350C.

Thus, one way to view the relationship between a planning item 310 and planning components 350A, 350B and 350C is to view each planning item 310 as being associated with a set of planning components 350A, 350B and 350C. Planning components 350A, 350B and 350C may be any type of quantitative data that may be useful for supply chain collaboration and planning. Each planning component 350A, 350B and 350C comprises a series of time dependent pieces of data 366 including a start date, a duration, and a quantity. Thus, the planning component 350A, 350B and 350C is any time-phased series of planning data stored in the system that has a start date, a duration, and a quantity that can be displayed over a time period such as weekly, monthly, quarterly, and the like, that can be identified by at least two attributes.

Each planning component 350A, 350B and 350C is associated with a planning item 310 and consists of any type of time series data used by supply chain trading partners, such as supply chain or planning data, used to coordinate, schedule and plan supply chain activities. FIG. 3C is a more detailed depiction of one of the planning component 350A, 350B and 350C illustrated in FIG. 3B. The planning component 350 comprises of a series of cells 370. Each of the cells 370 corresponds to a piece of time series data. Each cell 370 generally has at least three pieces of information, a start date 372, a duration 374 and quantity 376. The information stored in these cells 370 is planning data that may be viewed and/or manipulated by users 250. Alternatively, each cell may only store a quantity 376 and a start date 372 without a duration 374. In such an embodiment, each cell is automatically defined as some daily or incremental bucket.

To illustrate, suppose in the previous example, the distributor A 150 had a planning component 350 for a demand forecast for widgets in sales region one. One of the cells 370 for the planning component 350 (identified as demand forecast for widgets in sales region one) may contain the following information: January 1^{st}; 3 months; and 500 units. This means that from January 1^{st} until April 1^{st} (i.e., 3 months from January 1^{st}), the distributor A 150 is expecting to have a demand for 500 units of widgets in sales region one. Meanwhile, another cell 370 for this planning item 360 may contain a demand forecast for widgets in sales region one 160 from April 2^{nd} to June 2^{nd}.

Using the system 200, a user 250 may share planning components 350 with other users 250 and/or trading partners 255. Users 250 having access to planning components 350 of another user 250 may import data from the other user's planning components 350 and put them into their own planning components 350. Specifically, only those users 250 assigned to roles (which will be discussed below) that grant the right to edit may access and edit the planning component 350. Other users 250 may be assigned to roles that grant them only read-only type access to particular planning components 350. In such cases, the user 250 will not be able to edit the contents of the planning components 350 but may access the contents of the planning component for viewing and/or data importing and/or data manipulation (which is discussed below).

When the users 250, the user's enterprise 265 and/or the system administrator 260 need to make changes to a planning component 350, the users 250, the enterprise 265 and/or the system administrator 260 may choose to generate a new version of the component 350. In one implementation, each version is automatically saved and stored independently of each other. For example, a user 250 might want to store different versions of a demand forecast using different values for different scenarios.

Trading partners may share data by forming partnerships. Partnerships define each partner's accessibility to the other partner's data such as planning items 310 and components 350. Several types of access may be granted. For example, a trading partner may grant to other trading partners, only read-only access to certain planning components 350, while for other types of planning components 350, the trading partner may also grant editing access. A trading partner may allow other trading partners to only view forecasting data but may allow other trading partners to edit order data.

Another feature of the present invention is the system's 200 ability to create a derived planning component. A derived planning component is a planning component that is determined from the values of other planning components. A derived planning component may be created by using the values of other planning components together with arithmetic operators such as addition, subtraction, multiplication, division, and the like, to fashion an equation which generates the derived planning component. For example, a derived component, such as a forecast, may be calculated as the sum of two defined planning components, a statistical forecast of future sales based on current conditions and forecasts of changes to future sales from promotions.

Unlike regular planning components 350, derived planning components cannot be edited or changed directly. The only way to change a derived planning component is to make changes to the planning components 350 from which the derived planning components are created. Since a derived planning component is derived from existing planning components 350, it is typically created when a user 250 requests it and is expunged when the user 250 no longer has a need for it.

A user 250, the user's enterprise 265, a trading partner 255 or the system administrator 260 may create a derived planning component. For example, after the user 250 logs on to the system 200, the system 200 allows the user 250 to create a formula for deriving a derived planning component. The formula uses the names of the planning components 350, from which the derived planning components are formed, and together with arithmetic operators, generate the derived planning components. Alternatively, a formula for deriving the derived planning component may use variables and arithmetic operators, where the variables are set to equal the planning components 350 from which the derived planning components are formed. Once the equation is completed, the user 250 may name the derived planning component. The user 250 may then save the derived planning component (i.e., the equation for deriving the derived planning component) for future use. The user 250 may then reference the derived planning component afterwards to obtain the derived planning component automatically. Once the user logs off the system, the data derived from the derived planning component formula is generally lost, but can be automatically recreated as described above.

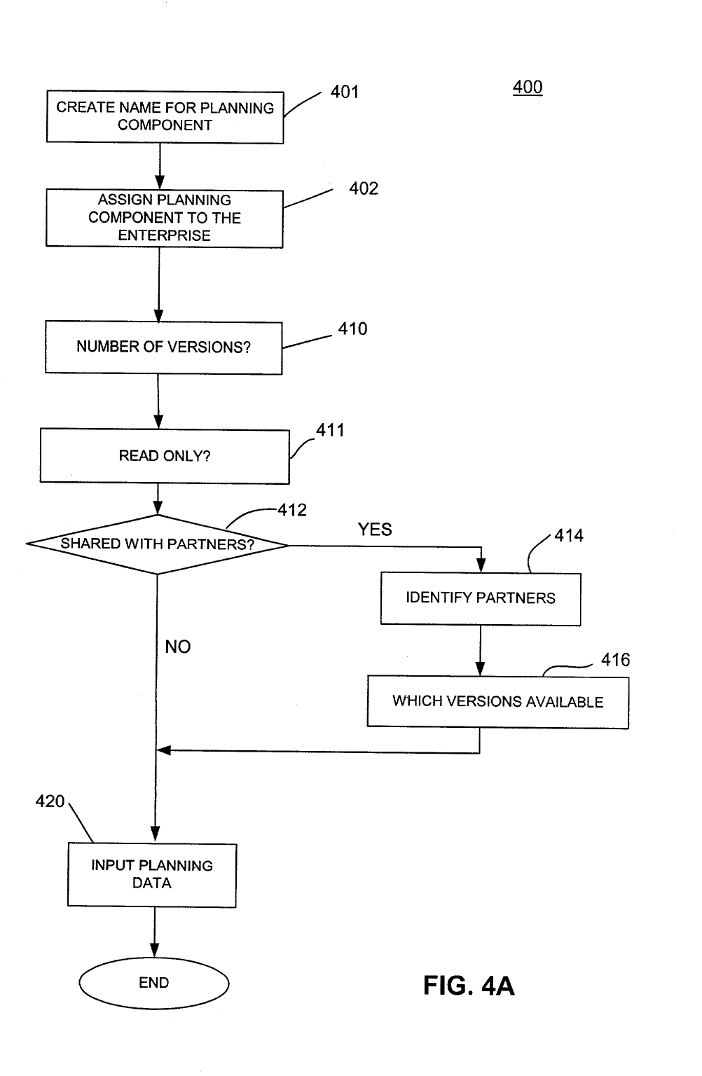

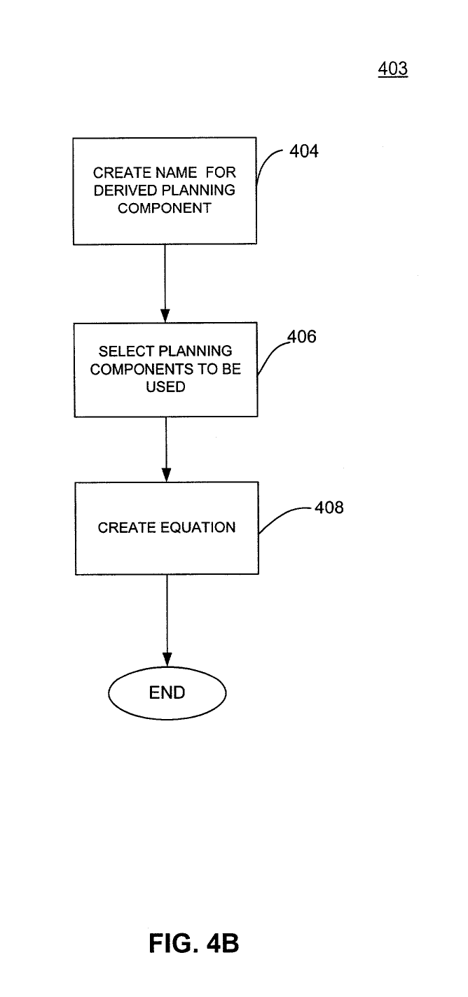

FIG. 4A presents a process 400 for creating a planning component 350 according to one embodiment of the present invention. At step 401, a name is created by the system 200 for the planning component 350. Associated with the planning component 350 named in step 401 will be a set of cells 370 where the planning data is stored. At step 402 the system 200 assigns the planning component 350 to a trading partner 255 and 265 who “owns” and “manages” it. By “owning” the planning component 360, the trading partner 255 and 265 and/or its users 250 is able to edit the contents of the component 350 as well as grant permission for others to access the component 350. At step 410, the system 200 determines the number of published and unpublished versions of the planning components 350 that may exist at any given time. Published versions are the versions of the planning components 350 that authorized users 250 and/or trading partners 255 and 265 may access. At step 411, determine whether the versions will be read-only access. The system 200 then determines whether the planning component 350 will be shared with other trading partner[s] 255 at step 412. If the planning component 350 is shared with other trading partner[s] 255 then those trading partners 255 are identified at step 414. For each of the trading partners 255 identified in step 414, a decision is made as to which versions of the planning components 350 will be accessible to the trading partner 255, step 416. Typically, there are at least two types of access, read-only access and access to view and edit the planning data (i.e., planning component 350). Of course, other types of access may also be contemplated. Finally, the planning data may be stored in the cells 370 associated with the planning component 350 at step 420. Note that those skilled in the art will recognize that the order in which the steps are outlined in the flow diagram of FIG. 4 is not strictly required and may be placed in a different order. For example, step 410 may occur after steps 416.

FIG. 4B presents a process 403 for creating a derived planning component. At step 404, the system 200 creates a name for the derived planning component. At step 406, the system 200 chooses which of pre-existing planning components will be used to generate the derived planning component. Pre-existing planning components are planning components 350 already stored in the database 210. At step 408 the system 200 creates an equation or formula needed for deriving the derived planning component using the pre-existing planning components selected in step 406. The equation is created from arithmetic operators and names of planning components 350 selected in step 406. Alternatively, variables may be used in the equation instead of names of planning components 350 by setting the variables equal to the planning components 350.

Referring back to FIG. 2, the security module 240 provides a means for controlling user 250 access to the planning data stored in the system 200. In one embodiment there are at least two means by which the security module 240 controls user 250 access to the planning data. A first means of controlling user access to planning data, which was briefly introduced earlier, is to assign roles 242 to users 250. A user's 250 access to a particular planning data will depend upon the role that the user 250 has been assigned. That is, being assigned to a particular role grants the user access to selected planning data related to that role. Also, preferably the system 200 allows for different types of access. For example, one type of access to planning data may grant a user only read-only access to a particular planning data. While another would be to grant both read and editing access, as described above in FIG. 4A.

Typically, roles 242 are assigned to users 250 by the system administrator 260 or a user 250 who is authorized to assign roles to other users or the user's enterprise 265. Those skilled in the art will recognize that the assignment of roles to users may be easily implemented in a number of ways.

To illustrate the use of roles 242, an example using the supply chain 100 of FIG. 1 is now provided. Suppose the distributor A 150 maintains a demand forecast that the distributor A 150 uses to determine how many widgets to order from the manufacturer 140. To optimize operation of the supply chain and to prevent any disruption in the flow of widgets, the distributor A 150 may want supplier A 120 to access the demand forecast. To grant this access, the distributor A 150 and supplier A 120 forms a partnership which allows supplier A 120 to access the relevant data. Alternatively, the distributor A 150, may grant access to the relevant data via planning item mapping. Planning item mapping is typically created when partnerships are formed between trading partners 255. Such a partnership will defines which planning components 350 each partner may access.

A second means of controlling access to planning data is the employment of filters 244. Filters 244 may be used in two ways. First, filters 244 may be used by users 250, when viewing planning data, to query for specific planning data. Typically, a user 250 would create and customize their own filters so that only desirable planning data is viewed by the user when the customize filter 244 is employed. Filters may also be used, in association with user roles, to restrict user access to certain planning data. This is accomplished, for example, by assigning users 250 to specific roles, each role having a filter[s] 244 associated with the role. The associated filter[s] 244 restricts users 250 to selected data. Further, filters 244 enable a user 250 to automatically obtain specific planning data for viewing and/or editing without having to search through all the available planning data. For example, a user 250 may employ filters 244 to select only the forecast data for a particular sales district rather than an entire region. The user 250 may also add filters 244 to see subsets of planning data as illustrated below. Filters 244, as a result, allows the user 250 to design the types and forms of information that the user 250 views and edits, making the process of obtaining and disseminating information quicker and more efficient. A user 250 may create a plurality of filters 244 to be employed at the user's discretion.

To illustrate the utility of a filter 244, the following example is provided. Referring again to the supply chain of FIG. 1, suppose the manufacturer 140 has access to distributor A's 150 demand forecast for widgets. There is typically a large quantity of data associated with the demand forecast that is broken down into a number of planning items 310 based on product (i.e., widgets) and location (i.e., sales region one) and widget sizes (i.e., small, medium and large. However, the manufacturer 140 may be interested only in the forecast for widgets in sales region one for small sized widgets. To meet this need, the manufacturer 140 may create a filter 244 that queries only the forecast information for widget demand forecasts for region one 160 for small sized widgets. Alternatively, the manufacturer 140 may create a filter 244 that queries for forecasts for both small and medium sized widgets. Further still, the manufacturer 140 may create another filter 244 that queries for demand forecast for widgets in region one 160 for only large size widgets.

Generally, a third party, such as a system administrator 260, may create a filter for the user 250 and/or make available a pre-existing filter to the user 250. As a result, a user 250 may have for use several filters at any given time. Alternatively, users may 250 create their own filters 244.

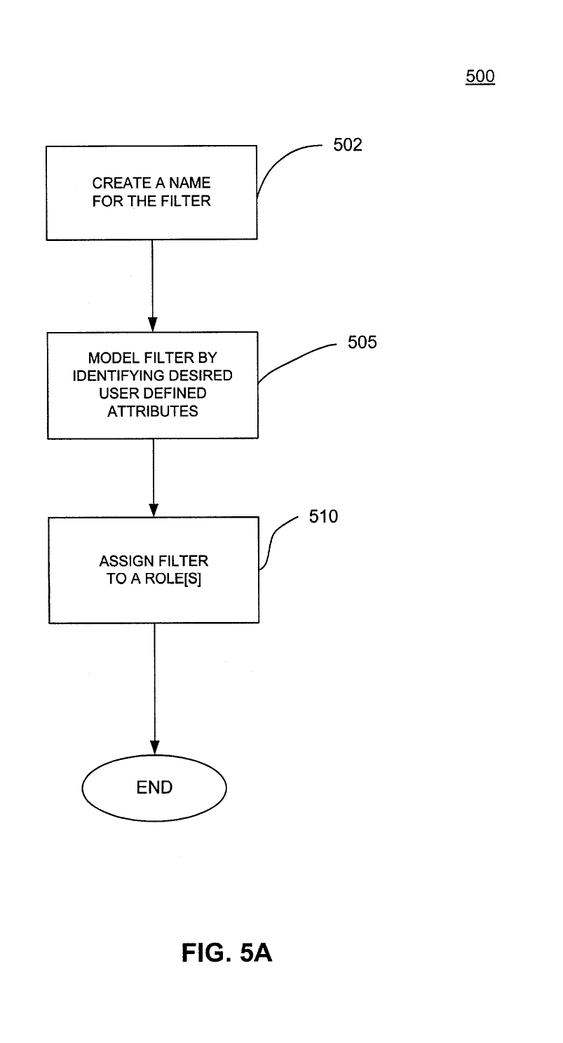

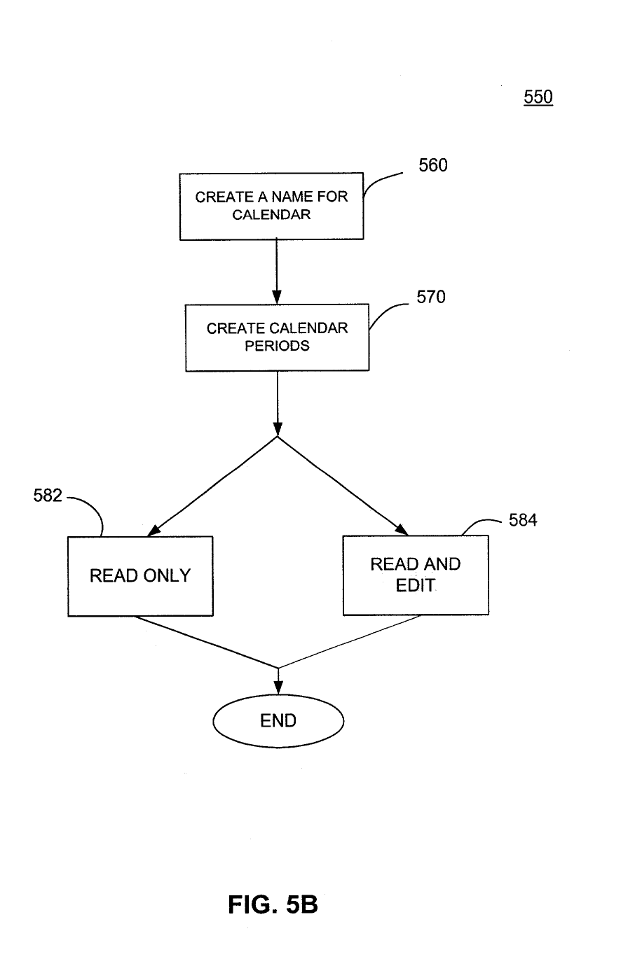

A filter 244 is basically a pre-defined query that may be created by either a user 250, a trading partner 255 and 265 and/or system administrator 260. FIG. SA depicts a flow process 500 for creating a filter 244 for use with user roles. The user 250, the enterprise 265 and/or administrator 260 creates a filter 244 by first naming the filter 244 at step 502. The user 250, the enterprise 265 and/or administrator 260 then models the filter by identifying user defined attributes used to query for the desired planning data at step 505. At step 510, the filter is assigned to a role or roles. Note also that the order in which the steps occurred in FIG. 5A is not essential and may be changed.

Returning to FIG. 2, the attribute module 224 allows users 250 to create and assign attributes to a product, location, planning item 310, or other data stored in the database 210. There are at least two types of attributes, identifiers and nonidentifiers. Identifier attributes are attributes used to identify planning items 310. These attributes allow users 250 to organize and view the planning data by being the basis for filters 210, hierarchies, and aggregation (hierarchies and aggregation are described in greater detail below). Nonidentifier attributes provide certain functional roles. For example, a nonidentifier attribute may be used to convert raw planning data into a more desirable form (the converting of raw planning data is discussed below).

By allowing users 250, enterprise 265 and/or system administrators 260 to create and assign an unlimited number of defined attributes to, for example, planning items 350, the user 250 is able to parse the planning data as needed. As a result, the user 250 is able to organize and obtain different views of the same data. Further, these user defined attributes facilitate the manipulation of data. For example, as stated earlier, a minimum of two attributes are generally needed to identify a planning item 310, a product name and a location. However, a user 250 may create additional attributes to further define a planning item 310. For example, in the previous example, planning data related to a planning item 310 with a planning component 350 was based on a widget demand forecast for sales region one 160. By creating a user defined attribute based on product size (such as small and large), the planning data is more particularly defined. Further, by having this third attribute, the user 250 can obtain a more detailed forecast, such as the demand forecast for “small sized” widgets in sales region one 160. In addition, defining the planning data via the user defined attributes simplifies the manipulation of the planning becomes easier.

Returning to FIG. 2, another feature of the system 200 according to the present invention is the calendar module 226, which allows the user 250 to create one or more calendars and apply the calendars to a particular enterprise 265 (i.e., trading partner) for organizing and manipulating planning data. The calendars are used to view and organize time series data in different periods of time. More particularly, the calendars may be customized to help a user view and organize planning data in a manner such that it is compatible with the user's business, planning and/or operational calendars.

Planning data, when viewed by users 250, are typically viewed in the context of some period of time. A period of time is defined by a starting date and an ending date. The duration of time between these two dates makes up the period.

In most situations, planning data is not relevant to a user 250 unless the data is tied to some time period provided by a calendar. For example, a manufacturer 140 might want to work with monthly forecast data and weekly order data provided by a distributor 150. The forecast data by monthly periods may be very useful to the manufacturer 140 for purposes of ordering supplies. At other times, the manufacturer 140 might prefer to use a year's forecast data rather than monthly forecast data to, for example, develop a work force hiring strategy based on long-term projection. While at other times, the manufacturer 140 might prefer using a forecast based on some midrange time period, such as a forecast for six weeks, to determine whether production lines be placed off-line. In each of the above situations, the manufacturer prefers to view the relevant data broken down into different increments of time as needed for business decisions.

Further, many companies that participate in a supply chain do not operate by the standard one year, 12 month calendar that begins on January 1^{st}. Rather, their business operations, business projections, buying and selling activities, and the like, may be based on something other than the standard calendar. To illustrate, many companies base their operations on quarterly periods. Sometimes the calendar periods for these companies may begin and end at different dates other than the standard calendar starting and ending dates. For example, if the standard first quarter is from January 1^{st} to April 1^{st}, then a company that does not follow the standard calendar might have quarters that begin on January 27^{th} and ending on April 27^{th}. The calendar module 226 allows the user creating the calendar to select the day that the calendar begins thus matching the user's own calendar. Such a calendar allows the user 250 to view the planning data in a way that corresponds to the user operational calendar, making it more relevant to the user.

The user 250 may create several calendars, each calendar defined by unique start and end dates, and one or more contiguous time periods. Time periods may be setup in daily, weekly, monthly, quarterly, or totally arbitrary periods of time as defined by the user. For example, a user 250 could create two yearlong calendars, a forecast calendar having time periods of three months with a start date of February 21^{st}, and a shipping schedule calendar, with 14 day time periods having a start date of June 1^{st}. Optionally, a user may also create a view-only calendar. A view-only calendar allows users only to view the data as specified by the calendar and does not allow the user to modify the data. Thus, as illustrated above, the calendar module 226 allows users to create and customize individualized calendars and apply the calendar to the planning date for purposes of organization and manipulation.

FIG. 5B depicts a flow process 550 for creating a calendar in accordance with the present invention. At step 560, a name is created for the calendar. Preferably the name is unique so that no two calendar assigned to the same trading partner 255 and 265 will have the same name. Optionally, a description of the calendar may also be created and stored during the step of naming the calendar. At step 570, define time intervals or periods for the calendar. Time periods may be, for example, daily, weekly, monthly, quarterly or some other customize time period. The system defines the calendar as being a read-only calendar at step 582 or a read and edit calendar at step 584.

Another feature of the system according to the present invention is the hierarchy module 220, which allows each user 250 to create hierarchies for organizing and viewing planning data. A hierarchy is an ordered grouping of planning items 310 based on their attributes. In doing so, a hierarchy allows a user 250 to view data from different perspectives. Recall that attributes 320 to 324 identify planning items 310. By organizing the attributes 320 to 324 into a hierarchical structure, the system 200 provides to the viewer (i.e., user 250), an organized and/or aggregated view of the planning data contained within planning items 310 and stored in the system 200.

Hierarchies are unique to each trading partner 255 (i.e., enterprise 265) and may be created by a system administrator 260, a trading partner 255 and 265, or by a user 250. Customized hierarchies may be created based on any attribute 320 to 324, such as location and product size. By organizing the planning items 310 into a hierarchy based on attributes 320 to 324, the system 200 described herein allows users 250 to have greater flexibility in viewing planning data.

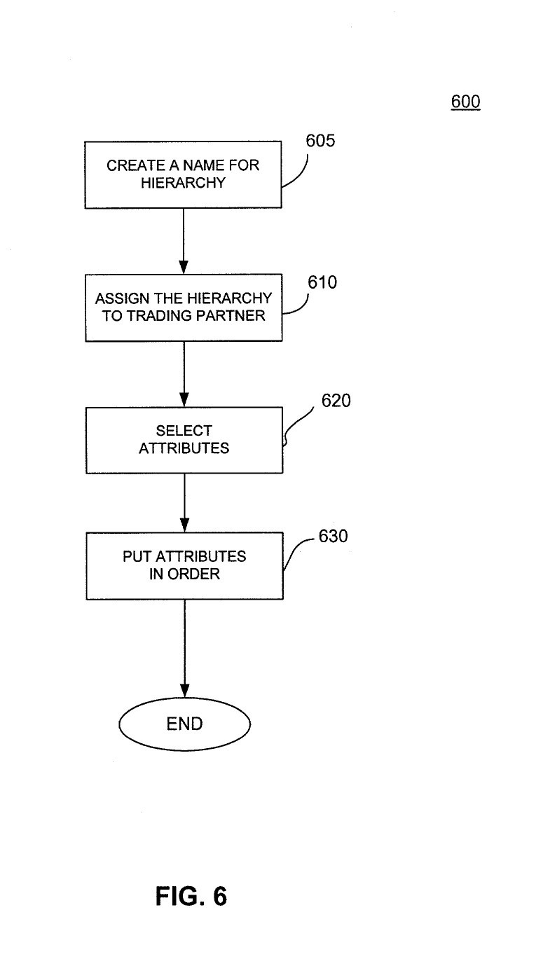

FIG. 6 depicts a flow process 600 for creating a hierarchy. At step 605, a name is created for the hierarchy. Optionally at step 605, a description of the hierarchy may also be created and stored with the hierarchy name. At step 610, assign the hierarchy to a trading partner 255 and 265. At step 620, select the attributes that are used in the hierarchy. Finally, at step 630, rank and place the attributes in hierarchical order. Note that the exact order of the steps illustrated FIG. 6 is not essential to the implementation of this embodiment of the invention.

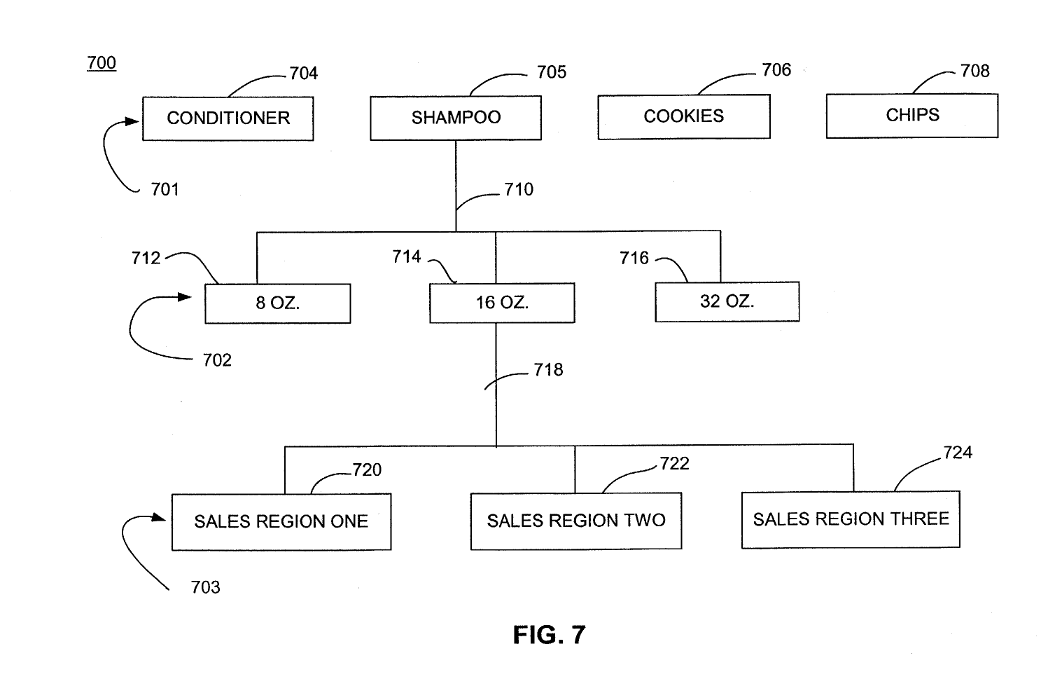

A hierarchy is made up of hierarchical tiers. The way the data may be viewed by a user 250 will depend upon how the hierarchy is organized and which tier a user 250 chooses for viewing the data. To illustrate, the following example is provided in FIG. 7 depicting an exemplary hierarchy 700. The hierarchy 700 comprises of three tiers 701, 702 and 703. The top tier 701 is based on product identifiers (e.g., product names) comprising of four products, conditioner 704, shampoo 705, cookies 706 and chips 707. The middle tier 702 is based on product size and is lower in the hierarchy 700 then the top tier 701. Specifically, in FIG. 7, the items depicted in the middle tier 702 are the different product sizes available for the top tier product, shampoo 704, and comprises of 8 oz. 712, 16 oz. 714, and 32 oz. 716. The top tier product, shampoo 704, is connected to the middle node items 712, 714 and 716 by a first branch 710. The bottom tier 703 is based on sales districts. At the bottom of the second branch 718 for shampoo in 16 oz. size are three sales districts, Sales Region A 720, Sales Region B 722, and Sales Region C 724, that are located at the bottom tier 703. Although not shown, the other products at the top level (i.e., conditioner 704, cookies 706, and chips 707) may also have similar hierarchical branches extending into the middle and bottom tiers 702 and 703. Note that the bottom tier items (Sales Region A 720, Sales Region B 722, and Sales Region C 724) correspond to planning items having the attributes: “shampoo” for the product attribute; “16 oz.” for a user defined size attribute; and either Sales Region one, two or three for the location attribute. Thus, each tier 701, 702 and 793 of the hierarchy 700 comprises of various planning items. The planning items located in the top two tiers 701 and 702 are the aggregation of lower tiered items located along the same branch line. For example, the 16 oz. 714 in the middle tier 702 is the aggregate of the three sales regions 720, 722 and 724 located at the bottom tier 703 along the same branch 718.

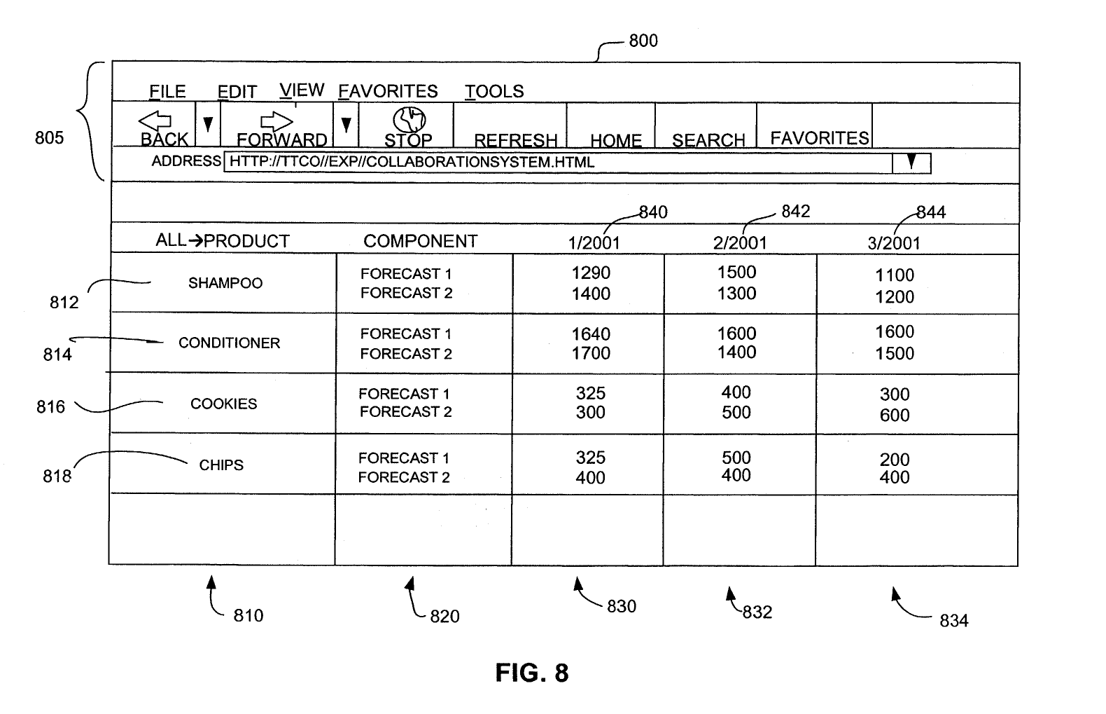

The functional role of a hierarchy may be better understood with the following example. FIG. 8 is an exemplary display 800 of a user interface for viewing planning data based on the hierarchy 700 described above. A user 250 may view the planning data via a browser, for example, Microsoft Explorer®. The display 800 illustrated here is the view of the planning data from the top tier 701 (i.e., product tier level) of the hierarchy 700. The top portion 805 of the display 800 is the tool bar for an Internet browser such as Microsoft Explorer®. The top tier products are listed in the first far-left column 810. The second column 820 lists the two types of forecasts stored for each product. The three far right columns 830, 832 and 834 show the time-series planning data (e.g., stored in planning components 350) for specific time periods 840, 842 and 844. This display 800 is an aggregate view of the planning data for each product because the forecast data located in the far right columns 830, 832 and 834 are not subdivided into values specifically related to a particular product for a particular product size in a particular sales region. Instead, each of the values located in the far right columns 830, 832 and 834, is a forecast for all subtypes of the products in column 810 in all product sizes and in all locations. For example, the value “1290” for forecast 1 for shampoo on 1/2001 is really the aggregate sum of all planning components 350 having the attributes “shampoo” and “forecast 1” regardless of size attribute or location attribute. The value “1290” is what is generally called an “aggregate planning component” or “aggregate planning data.”

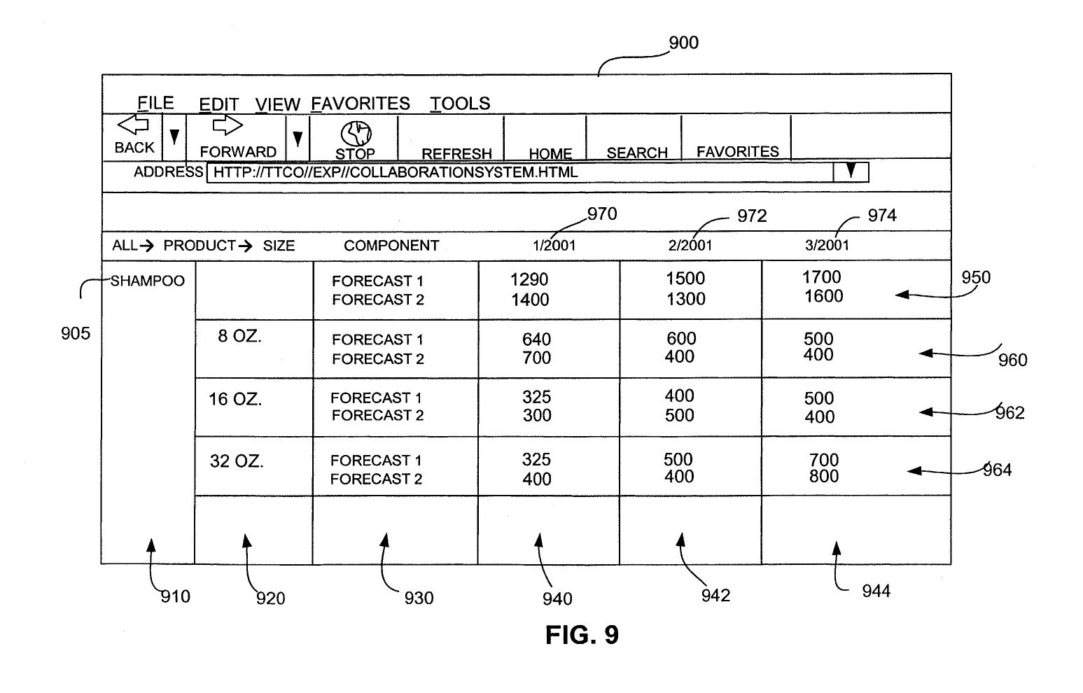

If a more detailed view of the planning data (i.e., planning component) is desired, then the user 250 may elect to view the planning data from the middle tier 702. For example, to display more specific information, such as forecasts for different sizes of shampoo, the user 250 may elect to view the data from the middle tier 702 of hierarchy 700. Referring now to FIG. 9, a display 900 depicts a user interface in which the user 250 has elected to view the planning data from the middle tier 702 of the hierarchy 700. The display 900 illustrated here is the middle tier 702 perspective with respect to the product, “shampoo”. Similar to FIG. 8, the display 900 is also an aggregate view summing forecast values for the bottom tier data (i.e., data by sales regions). Shampoo 905, the top tier item is identified in the first far-left column 910. The second column 920 contains the middle tier identifiers, in this case, the various sizes of Shampoo (i.e., 8 oz., 16 oz., and 32 oz.). The third column 930 indicates the two types of forecasts available for each of the different sized shampoo. The values located in the three far right columns 940, 942 and 944 are the time-series aggregate planning data for specific time periods. The specific time periods 970, 972 and 974 are shown at the top of the column. In this example, the periods 970, 972 and 974 are shown as single dates but alternatively may be displayed as a range of dates. The values located in the top row 950 are the aggregate values of all the corresponding forecast values for the 8 oz., 16 oz, and 32 oz. sized shampoo located in rows 960, 962 and 964. For example, in the first period represented in column 940, the aggregate value for shampoo forecast 1 is 1290, which is the sum of the values for forecast for the 18 oz., 16 oz., and 32 oz. sizes of shampoo on 1/2001. Thus, this view shows both the forecast values for different sized shampoos and the overall aggregate forecast values for shampoo (in the top row 950).

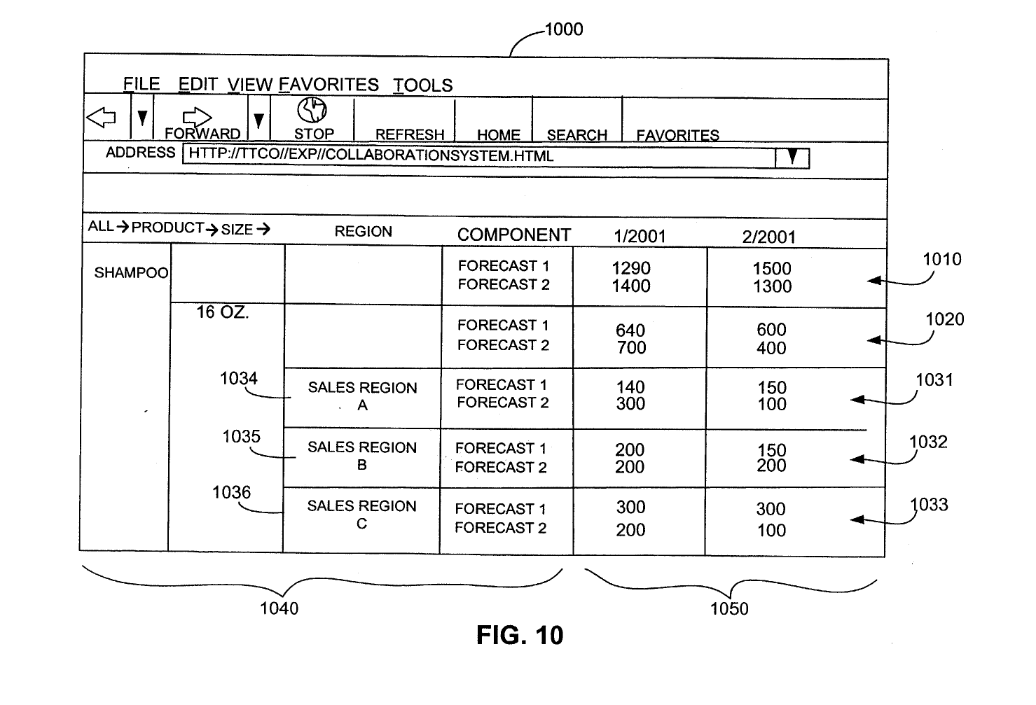

If the user 250 desires even more specific information relating to planning data for shampoo, such as the forecast data for each sales region for 16 oz. sized shampoo, the user 250 may elect to view the planning data for shampoo at the bottom node level. Referring to FIG. 10, a display 1000 depicts a user interface in which the user 250 has elected to view the planning data from the bottom tier 703. As in FIG. 9, a first top row 1010 of this display 1000 contains the aggregate values of shampoo forecasts for all sizes of shampoo in all sales regions, corresponding to rows 812 and 950 in FIGS. 8 and 9. A second row 1020 displays the aggregate values of 16 oz. shampoos for all sales regions for both forecast 1 and 2 corresponding to row 962 of FIG. 9. The values located at the bottom three rows 1031, 1032 and 1033, subdivide the aggregate values in row 1020 by different sales regions (i.e., Sales Region A 1034, Sales Region B 1035, and Sales Region C 1036). Note that the attributes listed on a far-left portion 1040 are the identifying attributes for the planning items that are being shown in this display 1000. Further note that the values located on a far-right portion 1050 represent data corresponding to cells 370 of the planning components 350.

Returning to FIG. 2, the freeze profile module 222 allows the user 250, the enterprise 265 (e.g., trading partner 255) and/or the system administrators 260, to create and employ freeze profiles. A freeze profile defines a time period during which planning data may not be changed in order to accommodate manufacturing or supply lead times. For example, to allow for lead-time to order parts, a production forecast or purchase order may be frozen for a period of time such as three weeks. This helps prevent a user 250 from making changes in the planning data stored in the system 200 that cannot be met by those users 250 in the supply chain responsible for meeting the requirements of the forecast or purchase order.

A freeze profile may be assigned to a single or a plurality of planning components 350. Referring back to FIG. 3C, a freeze profile, in essence, freezes planning component cells 370 that fall into the freeze period. A freeze profile consists of a time period. The start date for the freezing period may be the plan start date. The plan start date is generally a rolling start date that defines a trading partner's starting date for a forecast or business cycle. Typically a freeze profile is assigned to a planning item 310 and associated planning components 350. Within the freeze period, no one may change the data for any of the planning items 310 affected by the freeze profile. For an aggregated or derived planning component affected by freeze profiles, the planning components used to generate the aggregated or derived planning component with the longest freeze period determines the period during which the aggregated or derived component cannot be edited. When a freeze profile is created, it is associated with a particular trading partner 255 and 265.

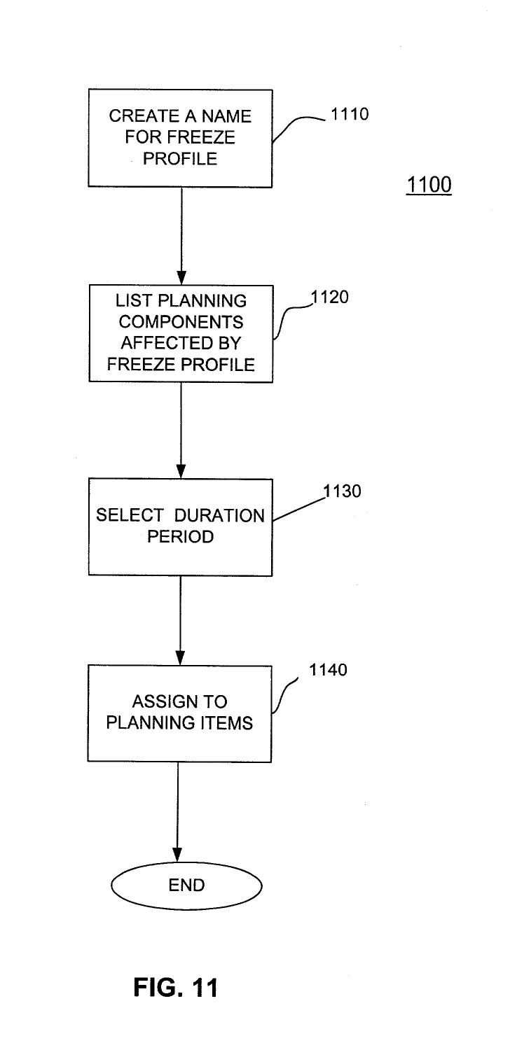

FIG. 11 is a flow process 1100 for creating a freeze profile. At step 1110, a name is created for the freeze profile. The name is preferably unique to the system and no other freeze profiles has the same name. Optionally, a description of the freeze profile may be created in this step. At step 1120, define the planning components affected by the freeze profile. At step 1130, duration in days of the freeze period is selected. At step 1140, the freeze profile is assigned to a planning item or items. That is, by assigning a freeze profile to a planning item 310, the freeze profile will apply to all of the planning components 350 associated with that planning item 310.

The Manipulation Module 228 allows users to manipulate the planning data stored in the system 200 in various ways and provides support to the other system modules. Among the services that the Manipulation Module may provide: Data Aggregation, Data Allocation, and Component Conversion.

Hierarchy data aggregation allows a user 250 to sum planning items 340 and planning components 350 when viewing planning data, thereby allowing the user 250 to view the data from various perspective. For example, as described earlier, when querying for a particular planning data, a user 250 may employ a hierarchy. The results of the query may be displayed on a user interface as illustrated in FIGS. 8-10. Planning components (both actual and derived planning components) at different hierarchical levels may be shown at the same time on the same user interface display (as illustrated in FIGS. 9-10). Data for planning items 310 from upper hierarchical levels will typically not be stored. For example, in FIG. 7, the planning items 310 in the top and middle tiers 701 and 702 may not be stored in the database 210. Instead, they may be generated from the bottom tier 703 planning items whenever needed. To generate the planning components 350 for the higher hierarchical tiers (e.g., the values in the top two rows 1010 and 1020), the lower tier planning components (e.g., the bottom three rows 1030, 1032 and 1034) is therefore, aggregated.

The Manipulation Module 228 assists the user 250 and the other system modules to allocating planning data upon request. For example, since derived planning components are generated from other planning components, data from pre-existing planning components 350 must be retained to generate the derived planning component. Further, users 250 may sometimes want to import data from another user's planning component into their own planning component. The Manipulation Module 228 allows for such actions via component allocation. The manipulation module 228 allows users 250 to allocate data when editing aggregated planning items. When a user 250 edits at an aggregate level, for example, editing a top or middle tier item in FIGS. 7-10, the edits may be pushed down to the underlying planning items in a number of ways. Proportional allocation, for example, will allocate the aggregate edit proportionally across the underlying planning items based on that planning item's contribution to the total. A weighted allocation is when a user defined attribute is used as a weighted factor, and a calculation is performed to allocate the aggregate edit to the underlying planning items. This is used in the case for instance, in apparel goods, where you know there is a certain mix of sizes. The weighted factor will allocate the edit based on a predefined profile.

The manipulation module 228 further allows users 250 to convert planning data into different units of measure. For example, the Manipulation Module 228 allows the user to convert currency data stored in terms of dollars to other currencies. Similarly, the module may convert supply data based on weight to supply data based on volume. The system 200 uses various methods for converting planning data. For example, planning data is typically stored as units of measure. Units of measure define the quantity information for planning items into packaging and batching lots. Units of measure, however, do not define capacity information for planning items. Instead, capacity information is defined using standard volume, weight, and currency measurement systems. These measurement systems include a factoring mechanism that supports conversions to other units in the same measurement system. These measurement systems are also used to convert planning items' planning component data. In order to convert planning component data, attributes (either identifying or nonidentifying) that have a data type of number that has been designated as a measurement type must be created. Further, a value set for the measurement-type attribute when it is a part of a product, location, or planning item definition must be defined. To illustrate, suppose you create a planning item for hair conditioners. Associated with this planning item is a nonidentifier attribute called “COST.” Suppose further that the base unit of measurement for the conditioner is a bottle. You could then define the value for “COST” as the cost of a bottle of conditioner, for example, two dollars. The value entered as the base “COST” is used to multiply the planning item's planning component data to convert the raw planning data into a more desirable format. This feature allows users in a supply chain to easily convert raw planning data into a more desirable form for viewing. For example, suppose a user wants to see what is the value of conditioners stored in the user's warehouse. However, the planning data stored is based on number of bottles of conditioner. By employing the conversion feature, the user is able to quickly obtain the dollar value of the conditioner stored in his/her warehouse.

The system 200 may also employ conversion chains for conversion. A conversion chain consists of an ordered grouping of units of measure, with factors for converting quantities from one unit of measure to another. For example, a conversion chain for cookies might be defined as:

| UNIT OF | | |
|---|---|---|
| MEASURE | FACTOR | DESCRIPTION |
| Each | 1 | 1 box-the smallest unit |
| Case | 12 | 12 boxes, or eaches |
| Pallet | 24 | 24 cases, or 288 eaches |
| Truckload | 10 | 10 pallets, 240 cases, or 2880 |
| | | eaches |

A conversion chain must start with a factor of 1 for the “each” unit of measure. The system 200 converts quantities at one level of a conversion chain to quantities at the next higher or lower level by using or applying the factor. Suppose that the lowest level “each” in a particular conversion chain is called level A and the higher levels are B, C, and D. To convert quantities from any unit of measure to the next lower level, one embodiment of the system uses a calculation like this:

Quantity at level B=Quantity at level C times Factor at level C

To convert quantities from any unit of measure to the next higher level, one embodiment of the system uses a calculation like this:

Quantity at level B=Quantity at level A divided by Factor at level B

After creating a conversion chain, the chain may be saved by naming the chain. Once saved with a name, it can be assigned to any number of planning items. Each unit of measure that is defined can appear in multiple conversion chains. Only a trading partner 255 that owns planning items may create conversion chains.

This feature is especially beneficial for users 250 because various participants of a supply chain commonly have different definitions for units of measurements. For example, a trading partner may define a pallet as 24 cases of goods while another may define a pallet as 36 cases.

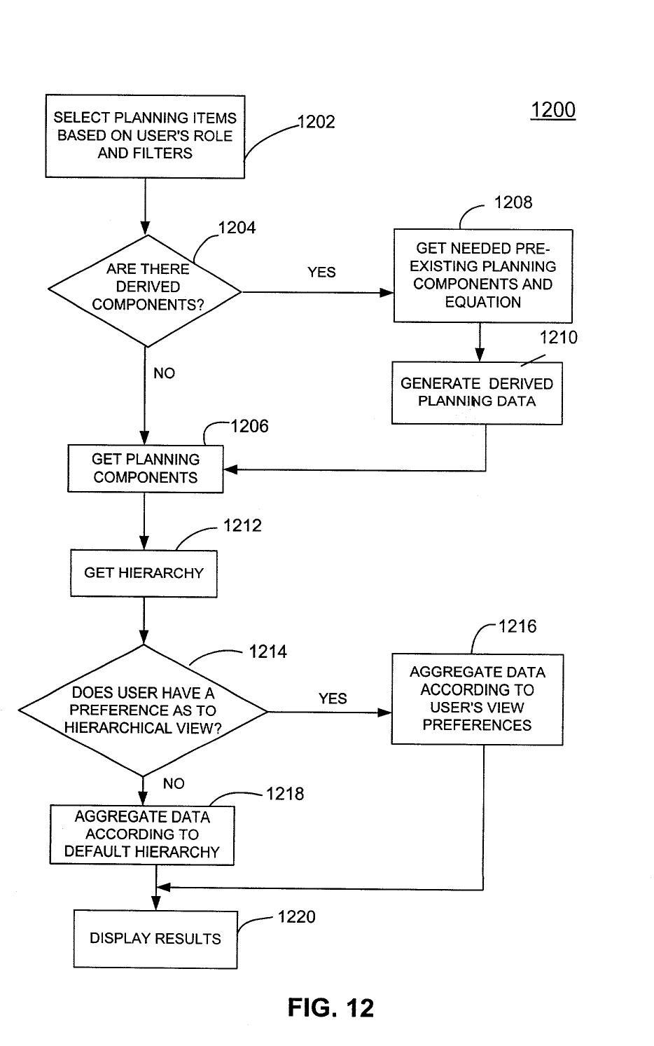

In a preferred embodiment, users 250 may log onto the collaboration system 200 from across a network, for example, the Internet, via a browser-based application. To fully appreciate the various features of the present invention, the following examples will now be provided. FIG. 12 is a flow process 1200 of how the collaboration system, according to the present invention, may obtain and use stored planning data and visually display the results of a user's query. After the collaboration system 200 has verified the user's login information and identification, the system 200 extracts only those planning items 310 and planning components 350 that satisfies the user's role and any filters associated with the role at step 1202. Recall that a specific role grants access to selected planning items 310 by employing filters. Further, trading partner partnerships will also restrict a user's access to particular planning components 310. As mentioned previously, partnership defines the type of access that users have to various planning data stored in the system 200. Preferably there is at least two types of access: read-only access and access to read and edit the planning component. Therefore, in step 1202, the system not only checks to see which planning items 310 the user 250 has access to, but also checks the type of access the user 250 has to the planning items 310. Recall also that filters are tools which sift through all the planning items 310 available to the user 250 and select only desired planning items 310. In a situation where a user 250 may have more than one filter, one of the filters may be designated as a default filter. A default filter is a filter that has been pre-selected to be the filter that is automatically activated when a user 250 first logs on to the system 200. A default filter may be a filter that has been created by the user 250 or one that has been previously created by the system administrator 260.

Once the targeted planning components 350 have been identified, the system 200 determines whether these components are derived components at step 1204. If none of the planning components are derived planning components then the system 200 proceeds to acquire the planning components from the database 210. If one or more of the planning components are derived components, then the system 200 obtains from the database 210, the formulas and the pre-existing planning components 350 needed to produce the derived planning component at step 1208. Once the formulas and pre-existing planning components have been obtained, the derived planning component may be generated at step 1210. At step 1212, the system 200 obtains the appropriate hierarchy for each planning item. At step 1214, the system 200 determines whether the user 250 prefers a particular hierarchical view of the planning components 350 that have been obtained at step 1214. This may be accomplish by having the user 250 select from which branch level node the user 250 wishes to view the planning data as was illustrated in FIGS. 8-10. If the user 250 has a view preference, the planning data is aggregated according to the user's view preferences at step 1216. However, if the user 250 has no preference, then the system aggregates the data according to the default view at step 1218. After aggregation of the planning data, the planning data may then be displayed on the user interface at step 1220.

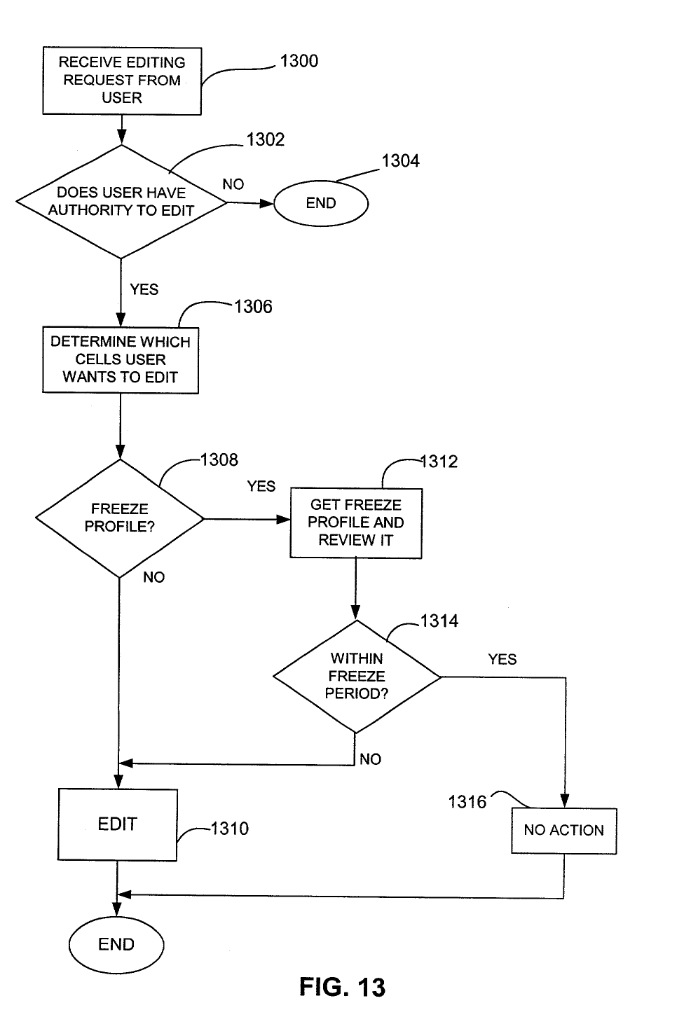

Referring now to FIG. 13 depicting a flow process for editing planning components 350. Initially, the system 200 receives a request by a user 250 to edit selected cells of a planning component 350 at step 1300. The system 200 determines whether the user 250 is authorized to edit the planning component 350 at step 1302. As previously described, the role that the user 240 has been assigned determines if the user 250 has the authority to edit the planning component 350. If the user 250 does not have the authority to edit the planning component 350, then the process ends at step 1304. The system 200 then reviews the editing request by the user 250 to determine the planning component cells 370 to be edited, step 1306. The system 200 then determines whether a freeze profile exists for the corresponding planning component 360 at step 1308. If there is no freeze profile for that planning component 350, then the system 200 allows the user 250 to edit the planning component 350 at step 1310. However, if there is a freeze profile, then the system 200 obtains the corresponding freeze profile and reviews it at step 1312. At step 1314, the system determines whether the targeted cells for editing are within the freeze period. If the targeted cells are indeed within the freeze period, then the system 200 allows no edits to the planning component cells 370 at step 1316. If, on the other hand, the targeted cells are outside the freeze period, then the system 200 allows edits to those cells at step 1310. Those skilled in the art will recognize that the steps described in the above process are general steps for carrying out the present invention and that specific steps may be modified, added or the order of the steps may be changed without departing from the spirit and scope of the invention.

The system 200 according to embodiments of the present invention supports various types of business flows that may exist in a supply chain. A business flow is the exchange of information and/or goods and services between business entities. In a supply chain, there are typically at least three major business flows: internal flows (between remote users within an enterprise); intra-flows (between unrelated trading partners using, for example, the Internet), and flows between trading partners and a host trading partner. The system described herein supports all three types of business flows.

According to the present invention, data between trading partners may be exchange using different information transfer protocols. For example, protocols such as EDI, XML, SMTP, FTP, MIME, HTTP, and the like are supported by the present invention. To ease the exchange of data between the trading partners, the data being exchange is preferably in Collaborative Planning, Forecasting, and Replenishment (CPFR) format. Each CPFR message may be specified in one of two data format standards: ANSI ASC X12 EDI or Standard Interchange Language (SIL). Further, the data being exchanged between trading partners may be in XML.

The foregoing description of the preferred embodiments of the present invention has been presented for the purposes of illustration and description. It is not intended to be exhaustive or to limit the invention to the precise form disclosed. It will be apparent to those of ordinary skill in the art that various modifications and variations can be made in the supply chain management system and method of the present invention without departing from the spirit or scope of the invention. Thus, it is intended that the present invention covers the modifications and variations of this invention provided that they come within the scope of any claims and their equivalents.

We claim:

1. A method for sharing and manipulating supply chain planning data, comprising the steps:
storing said planning data;
assigning attributes to said planning data;
creating a hierarchy based on said attributes; and
manipulating said supply chain planning data by aggregating said planning data in accordance with said hierarchy to produce aggregated planning data.

2. The method of claim 1, wherein said step of assigning attributes is performed by assigning a location attribute and a product attribute to each of said planning data.

3. The method of claim 2, wherein said step of assigning attributes further comprises the step of assigning a user defined attribute to each of said planning data.

4. The method of claim 1, wherein said step of creating a hierarchy is performed by ranking and placing one of said attributes into a hierarchical order.

5. The method of claim 4, wherein said planning data is based on a first unit of measure and said step of manipulating said planning data comprises the step of converting one of said planning data based on a first unit of measure to a planning data based on a second unit of measure.

6. The method of claim 5, wherein said step of converting one of said planning data further comprises the step of creating a conversion chain comprising a factor.

7. The method of claim 6, wherein said step of converting one of said planning data further includes the step of applying said factor to said one of said planning data based on a first unit of measure to a planning data based on a second unit of measure.

8. The method of claim 7, wherein the step of manipulating said planning data comprises the step of allocating aggregate edits for a first hierarchical item belonging to a first tier to at least two second hierarchical items belonging to tiers lower than said first tier in said hierarchy.

9. The method of claim 8, further comprising the step of assigning a role to a user.

10. The method of claim 9, wherein said role is associated with a filter.

11. The method of claim 10, further comprising the step of selecting one of said planning data by filtering said planning data using said filter.

12. The method of claim 11, wherein said step for filtering said planning data using said filter is performed by querying for one of said planning data having attributes as defined by said filter.

13. The method of claim 9, further comprising the step of creating a customized calendar based on said user's time period preferences.

14. The method of claim 13, wherein said step of manipulating said planning data further comprises the step of organizing and incrementing said planning data according to said customized calendar.

15. The method of claim 14, further comprising the step of creating a freeze profile.

16. The method of claim 15, wherein said freeze profile is defined by a freeze period.

17. The method of claim 16, further comprising the step of assigning said freeze profile to one of said planning data preventing said planning data from being edited during said freeze period.

18. The method of claim 1, further comprising the step of electronically transmitting said planning data to a computer device.

19. The method of claim 18, wherein said step of electronically transmitting said planning data to a computer device is via an electronic network..

20. The method of claim 19, wherein said electronic network is the Internet.

21. The method of claim 1, wherein said step of manipulating said planning data comprises the step of converting one of said planning data based on a first unit of measure to a planning data based on a second unit of measure.

22. The method of claim 21, wherein said step of converting one of said planning data further comprises the step of creating a conversion chain comprising a factor.

23. The method of claim 22, wherein said step of converting one of said planning data further includes the step of applying said factor to said one of said planning data based on a first unit of measure to produce a planning data based on a second unit of measure.

24. The method of claim 1, wherein the step of manipulating said planning data comprises the step of allocating aggregate edits for a first hierarchical item belonging to a first tier to at least two second hierarchical items belonging to tiers lower than said first tier in said hierarchy.

25. The method of claim 1, further comprising the step of assigning a role to a user.

26. The method of claim 25, wherein said role is associated with a filter.

27. The method of claim 26, further comprises the step of selecting one of said planning data by filtering said planning data using said filter.

28. The method of claim 26, wherein said step for filtering said planning data using said filter is performed by querying for one of said planning data having attributes as defined by said filter.

29. The method of claim 1, further comprising the step of creating a customized calendar based on a user's time period preferences.

30. The method of claim 29, wherein said step of manipulating said planning data further comprises the step of organizing and incrementing said planning data according to said customized calendar.

31. The method of claim 1, further comprising the step of creating a freeze profile.

32. The method of claim 31, wherein said freeze profile is defined by a freeze period.

33. The method of claim 32, further comprising the step of assigning said freeze profile to one of said planning data preventing said planning data from being edited during said freeze period.

34. A system for sharing and manipulating supply chain planning data, comprising:
means for storing said supply chain planning data;
means for assigning attributes to said planning data;
means for creating a hierarchy based on said attributes; and
means for manipulating said planning data by aggregating said planning data in accordance with said hierarchy to produce aggregated planning data.

35. The system of claim 34, wherein said assigning means is for assigning a location attribute and a product attribute to each of said planning data.

36. The system of claim 35, wherein said assigning means is for assigning a user defined attribute to each of said planning data.

37. The system of claim 34, wherein said hierarchy creating means creates a hierarchy by ranking and placing one of said attributes into a hierarchical order.

38. The system of claim 34, wherein said planning data is based on a first unit of measure, said manipulating means comprises a means for converting one of said planning data based on a first unit of measure to a planning data based on a second unit of measure.

39. The system of claim 38, wherein said converting means is for converting one of said planning data comprising a means for creating a conversion chain comprising a factor.

40. The system of claim 39, wherein said converting means is for converting said planning data by applying said factor to said one of said planning data based on a first unit of measure to produce a planning data based on a second unit of measure.

41. The system of claim 34, wherein said manipulating means further comprises of means of allocating aggregate edits for a first hierarchical item belonging to a first tier to at least two second hierarchical items belonging to tiers lower than said first tier in said hierarchy.

42. The system of claim 34, further comprising a means of assigning a role to a user.

43. The system of claim 42, wherein said role is associated with a filter.

44. The system of claim 43, further comprises a means for selecting one of said planning data by filtering said planning data using said filter.

45. The system of claim 44, wherein said filtering means is a filter that queries for one of said planning data having attributes as defined by said filter.

46. The system of claim 34, further comprising a means for creating a customized calendar based on a user's time period preferences.

47. The system of claim 46, wherein said manipulating means comprising a means for organizing and incrementing said planning data according to said customized calendar.

48. The system of claim 34, further comprising a means of creating a freeze profile.

49. The system of claim 48, wherein said freeze profile is defined by a freeze period.

50. The system of claim 49, further comprising a means for assigning said freeze profile to one of said planning data preventing said planning data from being edited during said freeze period.

51. The system of claim 34, further comprising a means for electronically transmitting said planning data to a computer device.

52. The system of claim 51, wherein said transmitting means electronically transmits said planning data to a computer device via an electronic network.

53. The system of claim 52, wherein said electronic network is the Internet.

54. A collaboration network for sharing supply chain information, comprising:
a database storing planning data;
an attribute module which assigns attributes to said planning data;
a hierarchy module which creates a hierarchy; and
a manipulation module which manipulates said planning data by aggregating said planning data in accordance with a hierarchy created by said hierarchy module to produce aggregated planning data.

55. The network of claim 54, wherein said attribute, hierarchy and manipulation modules are located on a server.

56. The network of claim 55, wherein said server is in communication with users via the Internet.

57. The network of claim 54, wherein said attribute module creates and assigns attributes to said planning data by assigning two attributes to each of said planning data.

58. The network of claim 54, wherein said hierarchy module creates a hierarchy by ranking and placing one of said attributes into a hierarchical order.

59. The network of claim 54, wherein said planning data is based on a first unit of measure, and said manipulation module converts one of said planning data based on a first unit of measure to a planning data based on a second unit of measure.

60. The network of claim 59, wherein said manipulation module creates a conversion chain comprising of a factor.

61. The network of claim 60, wherein said manipulation module applies said factor to said one of said planning data based on a first unit of measure to produce a planning data based on a second unit of measure.

62. The network of claim 54, wherein said manipulation module allocates aggregate edits for a first hierarchical item belonging to a first tier to at least two second hierarchical items belonging to lower tiers then said first tier in said hierarchy.

63. The network of claim 54, further comprising a security module that assigns a role to a user, wherein said role is associated with a filter.

64. The network of claim 63, wherein said security module further selects one of said planning data by filtering said planning data using said filter.

65. The network of claim 64, wherein said security module filters said planning data by querying for one of said planning data having attributes as defined by said filter.

66. The network of claim 54, further comprising a calendar module that creates a customized calendar based on said user's time period preferences.

67. The network of claim 66, wherein said manipulating module organizes and increments said planning data according to said customized calendar.

68. The network of claim 54, further comprising a freeze profile module that creates a freeze profile, wherein said freeze profile is defined by a freeze period.

69. The network of claim 68, wherein said freeze profile module assigns said freeze profile to one of said planning data preventing said planning data from being edited during said freeze period.

70. A program storage device readable by a machine, tangibly embodying a program of instructions executable by a machine to perform the steps of sharing and manipulating supply chain planning data, the steps comprising:
storing said planning data;
assigning attributes to said planning data;
creating a hierarchy by ranking and placing one of said attributes into a hierarchical order; and
manipulating said supply chain planning data by aggregating said planning data in accordance with said hierarchy to produce aggregated planning data.

71. The program storage device of claim 70, wherein said step of assigning attributes is performed by assigning a location attribute, a product attribute and a user defined attribute to each of said planning data.

72. The program storage device of claim 70, wherein said step of manipulating said planning data comprises the step of converting one of said planning data based on a first unit of measure to a planning data based on a second unit of measure.

73. The program storage device of claim 72, wherein said planing data is based on a first unit of measure, and said step of converting one of said planning data further comprises the steps of creating a conversion chain comprising a factor and applying said factor to said one of said planning data based on a first unit of measure to a planning data based on a second unit of measure.

74. The program storage device of claim 70, wherein the step of manipulating said planning data comprises the step of allocating aggregate edits for a first hierarchical item belonging to a first tier to at least two second hierarchical items belonging to tiers lower than said first tier in said hierarchy.

75. The program storage device of 70, wherein said program further comprises the steps of assigning a role associated with a filter to a user and selecting one of said planning data by filtering said planning data using said filter.

76. The program storage device of claim 75, wherein said step for filtering said planning data using said filter is by querying for one of said planning data having attributes defined by said filter.

77. The program storage device of claim 70, wherein said program further comprises the step of creating a customized calendar based on said user's time period preferences.

78. The program storage device of claim 77, wherein said step of manipulating said planning data further comprises the step of organizing and incrementing said planning data according to said customized calendar.

79. The program storage device of claim 70, wherein said program further comprises the step of creating a freeze profile, said freeze profile is defined by a freeze period.

80. The program storage device of claim 79, wherein said program further comprises the step of assigning said freeze profile to one of said planning data preventing said planning data from being edited during said freeze period.
